(19) United States
(12) Patent Application Publication
(10) Pub. No.: US 2004/0045666 A1
(43) Pub. Date: Mar. 11, 2004

(54) Hot melt adhesive and use thereof

(76) Inventors: Lie-Zhong Gong, Bridgewater, NJ (US); James W. Nowicki, Hopewell, NJ (US); Renu Lamba, Morganville, NJ (US); Jagruti B. Patel, Branchburg, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 10/236,270

(22) Filed: Sep. 6, 2002

(51) Int. Cl. C09J 1/00

(52) U.S. Cl. 156/334; 524/505

(57) ABSTRACT

A hot melt adhesive comprising ethylene copolymers, a tackifier and wax is useful in bonding substrates made of polymer laminated paperboard. The adhesive is particularly useful in packaging applications.

### FIELD OF THE INVENTION

The invention provides hot melt adhesives having excellent cold and heat resistance. The adhesive is particularly useful for bonding polymer laminated paperboard.

### BACKGROUND OF THE INVENTION

Cases and cartons used in the packaging of food and consumer goods are required to be resistant to cold and heat. Typically, full fiber tear for adhesive bonds at temperatures of from 0° F. to 140° F. is required. Although ethylene vinyl acetate (EVA) and ethylene N-butyl acrylate (EnBA) based hot melt adhesives are conventionally used for case and carton sealing operations, when this type of adhesive is used to bond substrates made from polymer laminated paperboard, bond strength suffers due to the inability of the adhesive to effectively penetrate the surface. In addition, the required cold and heat resistance is lacking, e.g., current commercially available EVA/EnBA based hot melt adhesives do not meet the heat resistance requirement (full fiber tear at 140° F.).

To insure that the cases/cartons to meet the required broad cold and heat resistance (0° F. to 140° F.), packaging companies usually use styrene-isoprene-styrene (SIS) and/or styrene-butadiene-styrene (SBS) based hot melt adhesive to seal cases or cartons made from polymer film laminated paperboard. While SIS/SBS based hot melt adhesive provides good adhesive bond integrity and excellent cold and heat resistance for polymer laminated substrate, it has several drawbacks. First, in contrast to EVA/EnBA hot melt adhesives SIS/SBS based hot melt adhesives have poor thermal stability. For example, viscosity may drop over 85% on being subjected to a standard thermal stability test at 350° F. for 72 hr. Poor thermal stability means short adhesive pot life. Moreover, resulting char may block hose and/or nozzles during adhesive application. Secondly, SIS/SBS based hot melt adhesives are not compatible with EVA/EnBA based hot melt adhesives, making it difficult (e.g., in terms of clean out, etc.) when the converter/packager wants to switch between the two types of adhesives during on-line adhesive application. Additionally, being very rubbery, hot melt adhesives based on SIS/SBS generally has a slow setting speed, resulting in a slow packaging line operation speed.

There is a need to develop EVA/EnBA based hot melt adhesives for use in bonding polymer laminated substrates that can provide the same good bond integrity and excellent cold and heat resistance (from 0° F. to 140° F.) as the SIS/SBS based hot melt adhesives while avoiding issues related to SIS/SBS. The current invention addresses this need.

### SUMMARY OF THE INVENTION

The invention provides a hot melt adhesive formulation having high heat resistance and cold resistance. Preferred adhesives will have a heat resistance of at least about 125° F., more preferably at least about 140° F., and a cold resistance of down to about 40° F., more preferably down to about 0° F., when used in case and carton sealing operations. The adhesive is particularly advantageous when used to bond together substrates made of polymer laminated paperboard.

The adhesive comprises a blend of ethylene copolymers, more particularly an ethylene copolymer having a high polar content and low melt flow index and an ethylene copolymer having a low polar content and high melt flow index. Typically, the ethylene copolymer having a high polar content and low melt flow index is present in the formulation in amounts greater than that of the ethylene copolymer having a low polar content and high melt flow index.

Adhesives of the invention will further comprise a polar tackifier and a wax, and may also optionally comprise a compatilizer. In a preferred embodiment, the tackifier is a terpene phenol having softening point of from about 115 to about 140° C. A preferred compatilizer is a terpene phenol having a softening point of less than about 115° C.

A particularly preferred adhesive comprises from about 20 to about 45 wt % of an ethylene vinyl acetate having a vinyl content of from about 33 to about 60 wt % and melt flow index of less than about 400 grams/10 minutes, from about 1 to about 30 wt % of an ethylene vinyl acetate having a vinyl content of less than about 32 wt % and a melt flow index greater than 400 grams/10 minutes, from about 2 to about 40 wt % of a terpene phenol tackifier having softening point of from about 115 to about 140° C., from about 0 to about 10 wt % a terpene phenol having a softening point of less than about 115° C., from 20 to 45 wt %, and from 0 to about 4 wt % of a stabilizer.

Article of manufacture comprising the hot melt adhesive, including but not limited to packaging cases and cartons, packaged articles, methods of sealing and/or forming a case, carton, tray, bag, book or the like using the adhesive, and methods of bonding a first substrate to a similar or dissimilar second substrate is encompassed by the invention. In the practice of the invention, at least one of the first or second substrate, or both may be a polymer laminated paperboard.

### DETAILED DESCRIPTION OF THE INVENTION

The invention provides hot melt adhesive compositions and methods of using the adhesives to bond a first substrate to a second substrate. In a preferred embodiment, at least one substrate to be bonded to a second substrate is a polymer laminated paperboard. The adhesives have good bond strength and high heat and cold resistance and are advantageously used in case and carton manufacturing and in sealing containers, such as cases or cartons, especially those that are made from polymer laminated paperboard.

It has been discovered that EVA/EnBA hot melt adhesives can be formulated that possess (1) good bond integrity and cold and heat resistance to bond polymer film laminated paperboard (full fiber tear from 0° F. to 140° F.), (2) better thermal stability than SIS/SBS based hot melt adhesives, (3) good compatibility with other EVA/EnBA based hot melt adhesives, (4) a faster setting speed than SIS/SBS based hot melt adhesives, (5) viscosity lower than 1500 cps at 350° F. to ensure being applicable using the current adhesive application equipment (e.g. slot extrusion from Nordson, Inc.), and (6) a cloud point lower than 330° F. to keep the hot melt adhesives as a single phase at the application temperature (e.g. 350° F.).

The adhesive compositions of the invention comprise at least one ethylene copolymer, and may comprise a blend of two or more polymers. The term ethylene copolymer, as used herein, refers to homopolymers, copolymers and terpolymers of ethylene. The polymer component will usually be present in an amount of from about 10% to about 60%, more preferably from about 20% to about 45%, more preferably from about 25% to about 35%. Examples of ethylene copolymers include copolymers with one or more polar monomers which can copolymerize with ethylene, such as vinyl acetate or other vinyl esters of monocarboxylic acids, or acrylic or methacrylic acid or their esters with methanol, ethanol or other alcohols. Included are ethylene vinyl acetate, ethylene methyl acrylate, ethylene ethyl acrylate, ethylene n-butyl acrylate, ethylene acrylic acid, ethylene methacrylate and mixtures and blends thereof. Other examples include but are not limited to recycled polyethylene terphthalate and polyethylene, ethylene/α-olefin interpolymers, poly-(butene-1-co-ethylene), atactic polypropylene, low density polyethylene, homogenous linear ethylene/α-olefin copolymers, lower melt index n-butyl acrylate copolymers, ethylene vinyl ester copolymers). Random and block copolymers, as well as blends thereof may be used in the practice of the invention.

Preferred adhesives for use in the practice of the invention comprise at least one ethylene n-butyl acrylate copolymer and/or ethylene vinyl acetate.

Ethylene n-butyl acrylate copolymers are available from Elf Atochem North America, Philadelphia, Pa. under the tradename Lotryl®, from Exxon Chemical Co. under the tradename Enable® (e.g., EN33330 which has a melt index of about 330 grams/10 minutes and an n-butyl acrylate content of about 33% by weight in the copolymer and EN33900 which has a melt index of about 900 and an n-butyl acrylate content of about 35% by weight) and from Millennium Petrochemicals under the tradename Enathene® (e.g., EA 89822 which has a melt index of about 400 grams/10 minutes and a n-butyl acrylate content of about 35% by weight in the copolymer).

Ethylene vinyl acetate copolymers are available from DuPont Chemical Co., Wilmington, Del. under the tradename Elvax® (e.g., Elvax® 210 which has a melt index of 400 grams/10 minutes and a vinyl acetate content of 28% by weight in the copolymer, Elvax® 205W which has a melt index of 800 and a vinyl acetate content of about 28% by weight in the copolymer and Elvax® 410 which has a melt index of 500 and a vinyl acetate content of about 18% by weight). Other ethylene vinyl acetate copolymers are available from Exxon Chemical Co. under the tradename Escorene® (e.g., UL 8705) and also from Millennium Petrochemicals, Rolling Meadows, Ill., under the tradename Ultrathene® (e.g., UE 64904) and AT® copolymers available from AT Polymers & Film Co., Charlotte, N.C. (e.g., AT® 1850M).

Particularly preferred adhesives comprise an EVA with a high vinyl content and low melt flow index, an EVA with a low vinyl content and high melt flow index, a polar tackifier and a wax. Particularly preferred EVA based hot melt adhesives comprise from about 20 to about 45 wt % of an EVA with a high vinyl content and low melt flow index, from about 1 to about 30 wt % of an EVA with a low vinyl content and high melt flow index, from about 2 to about 40 wt % of a polar tackifier, from about 0 to about 10 wt % of a compatilizer, from about 20 to about 45 wt % of a wax and may also include conventional additives such as, e.g., up to about 4 wt % of a stabilizer such as Organox.

EVA with a high vinyl content and low melt flow index will typically be present in amounts of from about 20 to about 45 wt % based on the weight of the adhesive. The vinyl acetate content will generally be from about 33 to about 60 wt %. High vinyl content EVAs useful in the practice of the invention will typically have melt flow indices of less than about 400 grams/10 minutes, more typically less than 100 grams/10 minutes.

EVA with a low vinyl content and high melt flow index will typically be present in amounts of from about 1 to about 30 wt %, more preferably in amounts from about 1 wt % to about 12 wt %, based on the weight of the adhesive. The vinyl acetate content will generally be below about 32 wt %. Low vinyl content EVAs for use in the practice of the invention will typically have melt flow indices greater than about 400 grams/10 minutes, more typically from about 900 to about 2500 grams/10 minutes.

In preferred embodiments, the amount of the high vinyl content, low melt flow index EVA will be present in the adhesive formulation in larger amounts than the low vinyl content, high melt flow index.

The adhesives of the invention will also comprise a polar tackifier. Preferred polar tackifiers for use in the practice of the invention are modified terpenes, preferable a phenol modified resin with a softening point of from about 115 to about 140° C. such as SYLVARES TP 2040 HM available from Arizona Chemical Company.

Terpenes are cyclic, unsaturated, C₁₀ hydrocarbons obtained from the Kraft process for making paper, turpentines and citrus oils. Examples of terpene compounds include alpha-pinene, beta-pinene, d-limonene, dipentene (racemic limonene), delta-3 carene, camphene, terpinene and the like. Preferred for use is alpha-pinene.

A phenolic compound has at least one hydroxyl group directly bonded to an aromatic ring. The parent phenolic compound is phenol itself. Other phenolic compounds are derivatives of phenol wherein 0 to 2 of the aromatic hydrogens are replaced with an equal number of substituents independently selected from hydroxyl; C₁-C₁₂ alkyl; C₁-C₁₂ alkyl substituted with 1 or 2 groups selected from hydroxyl and phenyl; phenyl; and phenyl substituted with 1 or 2 groups selected from hydroxyl and C₁-C₁₂ alkyl.

Specific derivatives of phenol include cresols (including the ortho, meta and para cresols), 1,3,5-xylenols, C₁₋₂₂ alkylphenol, iso-propylphenol, tert-butylphenol, amylphenol, octylphenol, nonylphenol, diphenylolpropane, phenylphenol, resorcinol, cashew nutshell liquid, bisphenol-A and cumylphenol. Phenolic compounds having a single substituent in the para position (relative to the hydroxyl group) include p-tert-butylphenol, p-octylphenol and p-nonylphenol. A preferred phenolic compound for use in the practice of the invention is phenol.

Particularly preferred hot melt adhesive compositions will also comprise up to about 10 wt % of a compatilizer. Useful compatilizers include rosin esters, C₅/C₉ hydrocarbon resins and low softening point terpene phenols. A terpene phenolic resin with a softening point lower than about 115° C., such as XR 7086 available from Arizona Chemical Company, is a preferred compatilizer for use in the practice of the invention.

Suitable waxes for use in the present invention include paraffin waxes, microcrystalline waxes, high density low molecular weight polyethylene waxes, by-product polyethylene waxes, Fischer-Tropsch waxes, oxidized Fischer-Tropsch waxes and functionalized waxes such as hydroxy stearamide waxes and fatty amide waxes. It is common in the art to use the terminology synthetic high melting point waxes to include high density low molecular weight polyethylene waxes, by-product polyethylene waxes and Fischer-Tropsch waxes. Modified waxes, such as vinyl acetate modified and maleic anhydride modified waxes may also be used. The wax component is utilized at levels of greater than about 10 weight percent, typically about 20 to 40 weight percent, by weight of the adhesive.

The paraffin waxes useful herein are those having a ring and ball softening point of about 55° C. to about 85° C. Preferred paraffin waxes are Okerin® 236 TP available from Astor Wax Corporation, Doraville, Ga.; Penreco® 4913 available from Pennzoil Products Co., Houston, Tex.; R-7152 Paraffin Wax available from Moore & Munger, Shelton, Conn.; and Paraffin Wax 1297 available from International Waxes, Ltd in Ontario, Canada. Particularly preferred are paraffin waxes having melting points in the range of about 130 to 170° F., such as, for example, Pacemaker available from Citgo, and R-2540 available from Moore and Munger; and low melting point synthetic Fischer-Tropsch waxes having a melting point of less than about 180° F. The most preferred wax is paraffin wax and blends thereof with a melting point of about 145 to about 165° F. Other paraffinic waxes include waxes available from CP Hall under the product designations 1230, 1236, 1240, 1245, 1246, 1255, 1260, & 1262. CP Hall 1246 paraffinic wax is available from CP Hall (Stow, Ohio).

The microcrystalline waxes useful here are those having 50 percent by weight or more cyclo or branched alkanes with a length of between 30 and 100 carbons. They are generally less crystalline than paraffin and polyethylene waxes, and have melting points of greater than about 70° C. Examples include Victory® Amber Wax, a 70° C. melting point wax available from Petrolite Corp. located in Tulsa, Okla.; Bareco® ES-796 Amber Wax, a 70° C. melt point wax available from Bareco in Chicago, Ill.; Okerin® 177, an 80° C. melt point wax available from Astor Wax Corp.; Besquare® 175 and 195 Amber Waxes and 80° C. and 90° C. melt point microcrystalline waxes both available from Petrolite Corp. in Tulsa, Okla.; Indramic® 91, a 90° C. melt point wax available from Industrial Raw Materials located in Smethport, Pa.; and Petrowax® 9508 Light, a 90° C. melt point wax available from Petrowax PA, Inc. located in New York, N.Y.

Exemplary high density low molecular weight polyethylene waxes falling within this category include ethylene homopolymers available from Petrolite, Inc. (Tulsa, Okla.) as Polywax™ 500, Polywax™ 1500 and Polywax™ 2000. Polywax™ 2000 has a molecular weight of approximately 2000, an Mw/Mn of approximately 1.0, a density at 16° C. of about 0.97 g/cm³ and a melting point of approximately 126° C.

The adhesives of the present invention preferably also contain a stabilizer or antioxidant. These compounds are added to protect the adhesive from degradation caused by reaction with oxygen induced by such things as heat, light, or residual catalyst from the raw materials such as the tackifying resin.

Among the applicable stabilizers or antioxidants included herein are high molecular weight hindered phenols and multifunctional phenols such as sulfur and phosphorous-containing phenol. Hindered phenols are well known to those skilled in the art and may be characterized as phenolic compounds which also contain sterically bulky radicals in close proximity to the phenolic hydroxyl group thereof. In particular, tertiary butyl groups generally are substituted onto the benzene ring in at least one of the ortho positions relative to the phenolic hydroxyl group. The presence of these sterically bulky substituted radicals in the vicinity of the hydroxyl group serves to retard its stretching frequency, and correspondingly, its reactivity; this hindrance thus providing the phenolic compound with its stabilizing properties. Representative hindered phenols include; 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate].

The performance of these antioxidants may be further enhanced by utilizing, in conjunction therewith, known synergists such as, for example, thiodipropionate esters and phosphites. Distearylthiodipropionate is particularly useful. These stabilizers, if used, are generally present in amounts of about 0.1 to 4 weight percent, more typically from about 0.25 to about 1.0 weight percent.

Such antioxidants are commercially available from Ciba-Geigy, Hawthorne, N.Y. and include Irganox® 565, 1010 and 1076 which are hindered phenols. These are primary antioxidants which act as radical scavengers and may be used alone or in combination with other antioxidants such as phosphite antioxidants like Irgafos® 168 available from Ciba-Geigy. Phosphite catalysts are considered secondary catalysts and are not generally used alone. These are primarily used as peroxide decomposers. Other available catalysts are Cyanox® LTDP available from Cytec Industries in Stamford, Conn., and Ethanox® 1330 available from Albemarle Corp. in Baton Rouge, La. Many such antioxidants are available either to be used alone or in combination with other such antioxidants. These compounds are added to the hot melts in small amounts and have no effect on other physical properties. Other compounds that could be added that also do not affect physical properties are pigments which add color, or fluorescing agents, to mention only a couple. Additives like these are known to those skilled in the art.

Depending on the contemplated end uses of the adhesives, other additives such as plasticizers, pigments and dyestuffs conventionally added to hot melt adhesives may be included. In addition, small amounts of additional tackifiers and/or waxes such as microcrystalline waxes, hydrogenated castor oil and vinyl acetate modified synthetic waxes may also be incorporated in minor amounts, i.e., up to about 10 weight percent by weight, into the formulations of the present invention.

The adhesive compositions of the present invention are prepared by blending the components in the melt at a temperature of above about 120° C., typically at about 150° C. until a homogeneous blend is obtained, usually about two hours is sufficient. Various methods of blending are known in the art and any method that produces a homogeneous blend is satisfactory.

The adhesives of the invention will typically be applied at temperatures of from about 300° F. to about 370° F. to about 350° F. to provide superior adhesive bonds even when bonded to polymer laminated paperboard including metalized polymer film laminated paperboard.

The adhesives possess excellent heat resistance and cold resistance. As defined herein, high heat resistance means the ability to maintain an acceptable fiber tearing bond at elevated temperatures of about 125° F., preferably 140° F. Cold resistance is the ability to maintain a high strength bond in the cold with no tendency to fracture at 40° F. (4° C.), preferably 0° F. Acceptable fiber tear as this term is used herein is considered to be at least 75% fiber tear or greater.

The hot melt adhesives of the invention find use in, for example, packaging, converting, bookbinding, bag ending, labeling and in the nonwovens markets. The adhesives find particular use as case, carton, and tray forming, and as sealing adhesives, including heat sealing applications, for example in the packaging of cereals, cracker and beer products. Encompassed by the invention are containers, e.g., cartons, cases, boxes, bags, trays and the like. The adhesive of the invention may also be used as a laminating adhesive.

The substrates to be bonded include virgin and recycled kraft, high and low density kraft, chipboard and various types of treated and coated kraft and chipboard. Composite materials are also used for packaging applications such as for the packaging of alcoholic beverages. These composite materials may include chipboard laminated to an aluminum foil that is further laminated to film materials such as polyethylene, polyethylene teraphthlate (PET, also referred to as mylar), acrylic coated oriented polypropylene (OPP), polyvinylidene chloride (PVC), ethylene vinyl acetate, foamed polystyrene and various other types of films. Additionally, these film materials also may be bonded directly to chipboard or kraft. The aforementioned substrates by no means represent an exhaustive list, as a tremendous variety of substrates, especially composite materials, find utility in the packaging industry.

Hot melt adhesives for packaging are generally extruded in bead form onto a substrate using piston pump or gear pump extrusion equipment. Hot melt application equipment is available from several suppliers including Nordson, ITW and Slautterback. Wheel applicators are also commonly used for applying hot melt adhesives, but are used less frequently than extrusion equipment.

In the following examples, which are provided for illustrative purposes only, all parts are by weight and all temperatures in degrees Celsius unless otherwise noted.

### EXAMPLES

Hot melt adhesives disclosed in this invention are subjected to the following tests.

Cold Resistance Test

Hot melt adhesive is applied to the paper liner side of a polymer film (e.g. PET, Acrylic coated OPP, PVC) laminated paperboard using a glass rod. A substrate is then placed onto the top of the hot melt adhesive with the polymer side facing to the hot melt adhesive. The paper-hot melt adhesive-polymer structure is compressed slightly for 2 S to form a bond. The resulting bonds are aged at RT for overnight and then conditioned in refrigerators for 24 hrs at 0° F., 20° F. 40° F., and, room temperature respectively. The bonds are taken out and pulled apart immediately by hand and the obtained fiber tear is recorded.

Heat Resistance Test

Bonds made above are conditioned in an oven at 140° F. for 6 hr and then are peeled apart immediately to record the fiber tear.

Hot Tack Test

The adhesive bonds are made at one second open time and 2 second compression time. The bond is then immediately pulled apart. The de-bonding force is recorded as measurement of the hot tack of the adhesive.

Cloud Point

An adhesive bead attached to a thermometer is allowed to cool down. The cloud point is defined as the temperature, at which the adhesive bead turns into hazy.

Thermal Stability Test

Adhesives are placed in an oven at 350° F. for 72 hr. Then the viscosity change is determined as a result of this process and is used as measurement for the adhesive thermal stability.

### Example 1

Hot melt adhesive Samples 1-6 having the components set forth in Table 1 were prepared by mixing all the components until homogeneous at 350° F. Bonds were made at 350° F. and were then aged at 0° F., 20° F., 40° F. and room temperature for 24 hours. The bonds were peeled apart and the percentage of fiber tear was recorded. Fiber tear of bonds aged in an oven 140° F. for 6 hours were employed to evaluate the heat resistance of the formulation.

Adhesive performance of Samples 1-5 of the invention, Comparative Sample 6 (an EVA/EnBA hot melt adhesive) and Comparative Sample 7 (a SIS/SBS blend hot melt adhesive) is shown in Table 2. Substrates for the adhesion tests were acrylic coated OPP laminated paperboard.

TABLE 1

| | Sample | | | | | |
|---|---|---|---|---|---|---|
| | 1 | 2 | 3 | 4 | 5 | 6 |
| IRGANOX 1010 FE | 0.5 | 0.5 | 0.5 | 0.5 | 1 | 1 |
| CIBA SPECIALTY CHEMICALS | | | | | | |
| CORPORATION, Antioxidant | | | | | | |
| CITGO PACEMAKER ® | 32 | 26 | 27.5 | 23.5 | 12 | 15 |
| 53 WAX | | | | | | |
| CITGO PETROLEUM | | | | | | |
| CORPORATION, Wax | | | | | | |
| PARAFLINT H4 | | | | | | 5 |
| SCHUEMANN SASOL AG, Wax | | | | | | |
| SHELL CALLISTA WAX 158 | | 6 | 6 | 10 | | |
| SHELL OIL PRODUCTS USA, | | | | | | |
| Wax | | | | | | |
| EPOLENE C-18 WAX | | | | | 7 | |
| EASTMAN CHEMICAL | | | | | | |
| COMPANY, Wax | | | | | | |
| Lotryl 35BA900 | | | | | 10 | |
| ATOFINA, EnBA | | | | | | |
| ESCORENE ULTRA UL 00226 | 5 | 6 | 8 | 2 | | |
| EXXONMOBIL CHEMICAL | | | | | | |
| COMPANY, EVA | | | | | | |
| Lotryl 35BA320 | | | | | 25 | 20 |
| ATOFINA, EnBA | | | | | | |
| ESCORENE UL 7710C | | | | | | 15 |
| EXXONMOBIL CHEMICAL | | | | | | |
| COMPANY, EVA | | | | | | |
| ELVAX 40W | 29 | 28 | 26 | 29 | | |
| E.I. DUPONT COMPANY, EVA | | | | | | |
| SYLVARES TP 2040 HM | 29 | 29 | 29 | 29 | | |
| ARIZONA CHEMICAL | | | | | | |
| COMPANY, Terpene | | | | | | |
| phenol | | | | | | |
| WINGTRACK EXTRA | | | | 6 | | |
| (MOLTEN) | | | | | | |
| GOODYEAR TIRE & RUBBER | | | | | | |
| COMPANY, Hydrocarbon | | | | | | |
| tackifier | | | | | | |
| SYLVALITE ® RE 105 | | | | | 45 | 24 |
| ARIZONA CHEMICAL | | | | | | |
| COMPANY, Rosin ester | | | | | | |
| SYLVARES TP | | | 3 | | | 10 |
| ARIZONA CHEMICAL | | | | | | |
| COMPANY, Terpene phenol | | | | | | |
| NORSOLENE A-110 | | | | | | 10 |
| SARTOMER COMPANY, INC, | | | | | | |
| Hydrocarbon tackifier | | | | | | |
| XR-7086 | 4.5 | 4.5 | | | | |
| ARIZONA CHEMICAL | | | | | | |
| COMPANY, Terpene phenol | | | | | | |

TABLE 2

| | Samples | | | | | | |
|---|---|---|---|---|---|---|---|
| | 1 | 2 | 3 | 4 | 5 | 6 | 7 |
| Adhesion at 0° F. | 100, 100 | 85, 95 | 80, 85 | 100, 60 | 100, 0 | 0, 0 | 1 |
| (fiber tear %) | | | | | | | |
| Adhesion at 20° F. | 100, 100 | 100, 100 | 100, 100 | 100, 50 | 30, 80 | 0, 10 | 100, 100 |
| (fiber tear %) | | | | | | | |
| Adhesion at 40° | 100, 100 | 100, 100 | 100, 100 | 80, 40 | 70, 50 | 0, 0 | 100, 100 |
| (fiber tear %) | | | | | | | |
| Adhesion at room | 100, 100 | 100, 100 | 100, 100 | 100, 30 | 100, 0 | 0, 20 | 100, 100 |
| temperature | | | | | | | |
| (fiber tear %) | | | | | | | |
| Heat resistance | 95, 80 | 100, 100 | 75, 70 | 90, 100 | 30, 40 | 0, 0 | cohesive failure, |
| at 140° F. | | | | | | | strong |
| (fiber tear %) | | | | | | | |
| Hot tack (Kg force) | >4.0 | >4.0 | >4.0 | >4.0 | >4.0 | >4.0 | >4.0 |
| Thermal stability | −6.50% | −8.50% | −9.50% | −12% | −19% | −16.3% | −89% |
| (viscosity change %) | | | | | | | |
| Cloud Point (° F.) | 295 | 310 | 300 | 300 | 270 | 260 | 190 |

From the data, it can be seen that Examples 1, 2 and 3 are particularly well suited for bonding together substrates made of polymer laminated paperboard. Each shows good adhesion at temperatures from 0° F. to 140° F. with excellent thermal stability. The Comparative Sample 7 possessed good adhesion but had very poor thermal stability.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A hot melt adhesive formulation having high heat resistance and cold resistance and comprising an ethylene copolymer having a high polar content and low melt flow index, an ethylene copolymer having a low polar content and high melt flow index, a polar tackifier, and a wax.

2. The adhesive of claim 1 wherein the tackifier is a terpene phenol resin.

3. The adhesive of claim 1 where the amount of the ethylene copolymer having a high polar content and low melt flow index in the formulation is greater than the amount of the ethylene copolymer having a low polar content and high melt flow index.

4. The adhesive of claim 1 comprising from about 20 to about 45 wt % of an ethylene vinyl acetate having a vinyl content of from about 33 to about 60 wt % and melt flow index of less than about 400 grams/10 minutes and from about 1 to about 30 wt % of an ethylene vinyl acetate having a vinyl content of less than about 32 wt % and a melt flow index greater than 400 grams/10 minutes.

5. The adhesive of claim 4 comprising from about 2 to about 40 wt % of a terpene phenol tackifier, said terpene phenol having softening point of from about 115 to about 140° C.

6. The adhesive of claim 5 further comprising a terpene phenol having a softening point of less than about 115° C.

7. The adhesive of claim 6 further comprising a wax.

8. The adhesive of claim 1 which has a heat resistance of equal to or greater than about 140° F.

9. An article of manufacture comprising the hot melt adhesive of claim 1.

10. The article of claim 9 which is a packaging case or carton.

11. A method of sealing and/or forming a case, carton, tray, bag or book comprising applying the hot melt adhesive of claim 1 to seal and/or form the case, carton, tray, bag or book.

12. The method of claim 10 wherein the adhesive is applied to a substrate made of polymer laminated paperboard.

13. A packaged article contained within a carton, case, tray or bag, wherein the carton, case, tray or bag comprises the adhesive of claim 1.

14. The packaged article of claim 13 which is a packaged food article.

15. A process for bonding a first substrate to a similar or dissimilar second substrate comprising applying to at least a first substrate a molten hot melt adhesive composition, bringing a second substrate in contact with the composition applied to the first substrate, whereby the first and second substrates are bonded together, said hot melt adhesive comprising the adhesive of claim 1.

16 The process of claim 15 wherein at least one of said first and/or second substrates is a polymer laminated paperboard.

17. The process of claim 16 wherein both of said first and said second substrate is a polymer laminated paperboard.
